(19) United States
(12) Patent Application Publication
(10) Pub. No.: US 2023/0022833 A1
(43) Pub. Date: Jan. 26, 2023

(54) MASONRY BASED MATERIALS WITH ANTI ODOR AND MICROBIAL CHARACTERISTICS

(71) Applicant: Rem Brands, Inc., Walton, KY (US)

(72) Inventors: Jonathan Schneider, Walton, KY (US); David Schneider, Union, KY (US)

(21) Appl. No.: 17/858,169

(22) Filed: Jul. 6, 2022

Related U.S. Application Data
(60) Provisional application No. 63/218,716, filed on Jul. 6, 2021.

(51) Int. Cl. C04B 24/20; C04B 28/14

(52) U.S. Cl. CPC C04B 24/20; C04B 28/14; C04B 2103/0076

(57) ABSTRACT

Antimicrobial and odor control masonry-based material compositions used to form a structure or surface include a base material and a halo active aromatic sulfonamide compound of Formula (I):

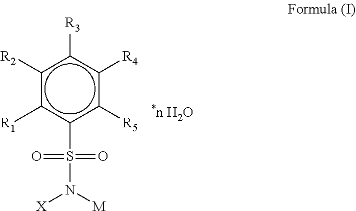

wherein the variables R₁, R₂, R₃, R₄, R₅, X, M and n are disclosed herein. The compositions and processes utilizing the same can be used to form surfaces and structures that maintain antimicrobial and odor-controlling properties over extended time periods.

### CROSS-REFERENCE TO RELATED APPLICATIONS

This application claims priority to U.S. Provisional Patent Application Ser. No. 63/218,716, filed on Jul. 6, 2021, which is incorporated by reference in its entirety.

### BACKGROUND

The present disclosure relates to masonry-based materials having antimicrobial and odor-controlling characteristics, including masonry-based materials such as cement, concrete, grout, mortar, and the like. More specifically, the present disclosure relates to masonry-based materials comprising a halo active aromatic sulfonamide compound, and processes utilizing the same, which can provide effective and long-lasting antimicrobial action as well as odor reducing properties. The antimicrobial and anti-odor masonry-based materials and associated processes find particular usefulness in settings and environments where exposure to bacteria and other microorganisms are prevalent and/or odor control is desired.

Conventional measures against contamination by microorganisms and undesirable odors typically involves surface cleaning, such as, for example, spraying and wiping using various disinfectants. Normal efficacy testing for disinfectants, sterilants, and sanitizers measure performance after a 30-second to 10-minute kill time. These protocols are mandated by various agencies (EPA, AOAC, etc.) to qualify a formulation for registration to claim particular kill performance. However, it is known that products such as bleach, hydrogen peroxide, or peracetic acid are essentially ineffective after they have dried on the surface they are applied to, and have almost no residual kill performance of microorganisms. It would be desirable to provide masonry-based materials that themselves have extended killing performance and odor-controlling properties over longer periods of time.

### BRIEF DESCRIPTION

It has been found that certain halo active aromatic sulfonamide compositions, and processes using the same, can provide extended microorganism killing performance and can be embedded or otherwise incorporated into various masonry-based material compositions to provide surfaces and structures (e.g., floors, walls, ceilings, and the like) with antimicrobial and odor-controlling properties. In certain circumstances, such surfaces and structures formed using the masonry-based material compositions of the present invention can exhibit a microbial kill performance that can extend for weeks to months and possibly years.

These and other non-limiting features or characteristics of the present disclosure will be further described below.

### DETAILED DESCRIPTION

A more complete understanding of the masonry-based materials and halo active aromatic sulfonamide compounds disclosed herein can be obtained by reference to the description below and the accompanying drawings. These figures are merely schematic representations based on convenience and the ease of demonstrating the present disclosure, and are, therefore, not intended to indicate relative size and dimensions of the articles or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Halo active aromatic sulfonamide organic compounds have been known to reduce or eliminate odor. Chloramine-T is an example of a sulfonamide organic compound which has been used in many applications. The usefulness of Chloramine-T is predicated on its ability to release an active chloride ion when needed on demand, immediately after which it simultaneously generates an active aromatic sulfo nitrene companion ion. The chlorine atom has a +1 formal charge in a hypochlorite ion, ClO⁻, which is the form taken by the chlorine atom when dissociated from the sulfonamide compound. Reference to the chlorine atom as having a +1 or 1⁻ charge may be used in this application interchangeably because this terminology has no effect on the compound itself or its use.

It has been found in the present disclosure that halo active aromatic sulfonamide organic compounds also have an antimicrobial performance that can extend over long periods of time. This may be useful in various commercial, industrial, governmental, and other institutional settings, including places such as waste-disposal sites, hospitals, nursing homes or long term care facilities, schools, detention facilities, travel hubs (e.g., airports, train stations, etc.), vehicles (e.g., boats, cars, airplanes, etc.), homes, fitness centers (e.g., gyms, weight rooms, etc.), or supermarkets. Whereas common disinfectants such as bleach, hydrogen peroxide, or peracetic acid are typically applied to a surface and then dry/evaporate within minutes, ending their disinfectant ability, it has been found that hydrates of halo active aromatic sulfonamide organic compounds will continue to exhibit disinfectant and odor-controlling ability over long time periods, such as over 24 hours, over 48 hours, over 72 hours, over 168 hours, or even as long as 336 hours (two weeks), or longer. It is believed that these compounds can also maintain such properties for longer periods, such as months or even years, so long as the active aromatic sulfonamide organic compound is present and has not been exhausted or decomposed. For example, the disinfectant and odor-controlling features may be maintained for at least 1 month, at least 2 months, at least 3 months, at least 4 months, at least 5 months, at least 6 months, at least 7 months, at least 8 months, at least 9 months, at least 10 months, at least 11 months, or at least 12 months, or more.

The halo active aromatic sulfonamide organic compounds also have several usage benefits over traditional disinfectants such as bleach or hydrogen peroxide. For example, bleach has a very strong chlorine odor in open air and during cleaning; is rapidly destructive for many surface types; only reduces microbes when wet, and has essentially no residual antimicrobial action once dry; has poor stability in “non-ambient” temperatures and light exposure; and is toxic, a skin and eye irritant, and a skin sensitizer. In contrast, compositions using halo active aromatic sulfonamide organic compounds can have equivalent antimicrobial performance, but also have long term residual antimicrobial action when dried on a surface; offer residual odor elimination when dry; have excellent stability, with a shelf life measured in years; and have extremely low toxicity, are not skin/eye irritating, and are not a sensitizer.

Definitions

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values).

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

As used herein, the terms “wt %” or “weight percent” denote the amount (i.e., weight) of a component per 100 units of the composition (i.e., 1 wt % of component A based on the weight of the composition is equivalent to 1 gram of A in every 100 grams of the composition).

It is expressly contemplated that the disclosure of two or more values also discloses ranges with a combination of any two of such values. For example, the disclosure of the ranges “about 0.1 wt % to about 10 wt %” and “about 0.5 wt % to 5 wt %” should be construed as also disclosing the ranges “about 0.1 wt % to about 0.5 wt %” and “about 5 wt % to about 10 wt %”.

The term “ambient temperature” refers to a temperature of 20° C. to 25° C.

The present disclosure may refer to temperatures for certain process steps. It is noted that these generally refer to the temperature at which the heat source (e.g. furnace) is set, and do not refer to the temperature which must be attained by the material being exposed to the heat.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “alkyl” refers to a radical composed entirely of carbon atoms and hydrogen atoms which is fully saturated. The alkyl radical may be linear, branched, or cyclic, and such radicals may be referred to as linear alkyl, branched alkyl, or cycloalkyl.

The term “aromatic” refers to a radical that has a ring composition containing a delocalized conjugated pi composition with a number of pi-electrons that obeys HUckel's Rule. The ring composition may include heteroatoms (e.g. N, S, Se, Si, O), or may be composed exclusively of carbon and hydrogen. Exemplary aromatic groups include phenyl, thienyl, naphthyl, and biphenyl.

The term “aryl” refers to an aromatic radical composed exclusively of carbon and hydrogen. Exemplary aryl groups include phenyl, naphthyl, and biphenyl.

The term “heteroaryl” refers to an aromatic radical containing at least one heteroatom. Exemplary heteroaryl groups include thienyl. Note that “heteroaryl” is a subset of “aromatic”, and is exclusive of “aryl”.

The term “alkoxy” refers to an alkyl radical which is attached to an oxygen atom, i.e. —O—CₙH₂ₙ₊₁, to a molecule containing such a radical.

The term “halogen” refers to fluorine, chlorine, bromine, and iodine.

The term “substituted” refers to at least one hydrogen atom on the named radical being substituted with another functional group, such as halogen, —CN, or —NO₂. Besides the aforementioned functional groups, an aromatic group may also be substituted with alkyl or alkoxy. An exemplary substituted aryl group is methylphenyl.

The term “alkali metal” refers to lithium, sodium, and potassium.

The term “alkaline earth metal” refers to magnesium and calcium.

As used herein, the term “antimicrobial” means an agent that will kill or inhibit the growth of microorganisms, such as, for example, bacteria, viruses, and fungi.

As used herein, the term “disinfect” means to inactivate, kill, or otherwise render non-pathogenic a pathogen, such as, for example, a bacteria, virus, for fungus.

As used herein, the term “killing performance” refers to the ability of a composition to inactivate, kill, or otherwise render non-pathogenic a microorganism, and may be measured as a function of the reduction in viability of a particular microorganism. The term “killing performance” may also have a time/duration dimension (i.e. killing performance at 24 hours, 48 hours, 72 hours, etc.).

Staphylococcus aureus (i.e. S. aureus) is a gram-positive bacteria commonly found on skin and in the nasopharynx. It can infect any human tissue, invade the body, and cause death. It is a leading cause of bacterial infections and death due to bacterial infections. Antibiotic treatment of S. aureus infection is complicated by widespread drug-resistance (MRSA, VRSA).

Pseudomonas aeruginosa (i.e. P. aeruginosa) is a gram-negative bacteria found throughout the natural and health care environment. It can infect any human tissue, invade the body, and cause death. It is a leading cause of bacterial infections and death in the immunocompromised, especially in cancer and burn patients. Antibiotic treatment of P. aeruginosa infection is complicated by widespread drug-resistance.

Clostridium difficile (i.e. C. difficile) is a spore-forming gram-positive bacteria that is highly prevalent in the environment. It is a common cause of antibiotic-associated diarrhea and may cause life-threatening infections. The spores of C. difficile survive long-term in the environment and contaminate many surfaces in hospital environments. C. difficile is anaerobic, grows only where there is no oxygen, and cannot survive outside the body as a living cell, therefore it forms bacterial endospores. C. difficile endospores are highly resistant to disinfectants and various forms of radiation, and can persist for years on surfaces. Antibiotic treatments for C. difficile infection are complicated by endospore formation in the body, as the dormant endospores are not affected by antibiotics. Effective methods for destroying bacterial endospores need to be developed to limit the infection of new hosts.

Masonry-Based Materials

The masonry-based material compositions of the present disclosure, which are used to form a final surface or structure, generally comprise: (A) at least one halo active aromatic sulfonamide compound, as described herein; and (B) a base material. As described further below, the halo active aromatic sulfonamide compound(s) may be variously incorporated in different states and the base material may comprise a variety of natural and synthetic components, aggregates, additives, and water.

The halo active aromatic sulfonamide compound(s) (A) used in the masonry-based material compositions of the present disclosure may have the structure of base Formula (I):

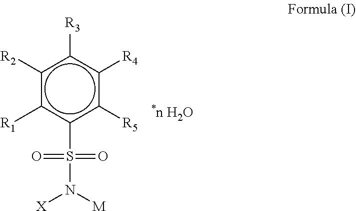

wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic;

R′ is hydrogen, an alkali metal, an alkaline earth metal, substituted C₁-C₁₈ alkyl, or unsubstituted C₁-C₁₈ alkyl; and

R″ is hydrogen or substituted or unsubstituted C₁-C₁₈ alkyl, where the two R″ groups in CON(R″)₂ and N(R″)₂ may be independently selected;

X is halogen;

M is an alkali or alkaline earth metal; and

n is the number of water molecules per molecule of the sulfonamide compound.

The term “aromatic”, as used herein, does not refer to a smell detected by the nose.

Generally, M is sodium or potassium. X is generally chlorine, bromine, fluorine, or iodine, and in particular embodiments is chlorine. Compounds of Formula (I) may or may not be hydrated, as indicated by the variable n. Generally, n may have any value from zero to 100, or even greater. In some specific embodiments, the compounds of Formula (I) are a trihydrate (i.e., n=3) or a hexahydrate (i.e. n=6). In other embodiments, the compound is in a solid form, such as a powder.

When the phenyl and/or alkyl group is substituted, one or more hydrogen atoms may be independently replaced with hydroxyl or halogen.

In particular embodiments of Formula (I), R₃ is methyl, COOH, or COOK; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; M₁ is an alkali or alkaline earth metal; and n is the number of water molecules per molecule of the sulfonamide compound.

In further embodiments, R₃ is methyl, COOH, or COOM₁; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; M is an alkali or alkaline earth metal; n is the number of water molecules per molecule of the sulfonamide compound; and at least one of R₁, R₂, R₄, and R₅ is not hydrogen.

In yet other embodiments of Formula (I), R₃ is selected from COOH, COOM₁, COOR′, CON(R″)₂, CN, NO₂, halogen, and substituted or unsubstituted C₂-C₁₈ alkyl; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; M is an alkali or alkaline earth metal; and n is the number of water molecules per molecule of the sulfonamide compound.

In still other embodiments of Formula (I), R₁, R₂, R₃, R₄, and R₅ are independently selected from hydrogen, COOH, COOM₁, NO₂, halogen, N(R″)₂, substituted or unsubstituted C₁-C₁₈ alkyl, and substituted or unsubstituted aromatic; X is halogen; M is an alkali or alkaline earth metal; and n is the number of water molecules per molecule of the sulfonamide compound.

In yet other embodiments of Formula (I), R₂ and R₄ are identical to each other; and R₁, R₃, and R₅ are hydrogen.

In yet other embodiments of Formula (I), R₂ and R₄ are hydrogen; and R₁, R₃, and R₅ are identical to each other.

In more specific embodiments of Formula (I), R₃ is selected from COOH, COOM₁, COOR′, and CON(R″)₂. Most desirably, R₃ is COOH or COOM₁, while R₁, R₂, R₄, and R₅ are hydrogen.

In other embodiments of Formula (I), R₁, R₂, R₃, R₄, and R₅ are independently selected from hydrogen, COOH, COOM₁, COOR′, CON(R″)₂, NO₂, halogen, N(R″)₂, substituted or unsubstituted C₁-C₁₈ alkyl, and substituted or unsubstituted aromatic; wherein at least one of R₁, R₂, R₃, R₄, and R₅ is not hydrogen; X is halogen; M is an alkali or alkaline earth metal; and n is the number of water molecules per molecule of the sulfonamide compound.

In still other embodiments of Formula (I), R₃ is COOH or COOM₁; R₁, R₂, R₄, and R₅ are independently selected from hydrogen, NO₂, halogen, N(R″)₂, substituted or unsubstituted C₁-C₁₈ alkyl, and substituted or unsubstituted aromatic; X is halogen; M is an alkali or alkaline earth metal; and n is the number of water molecules per molecule of the sulfonamide compound. In further specific embodiments, at least one of R₁, R₂, R₄, and R₅ is not hydrogen.

In some embodiments of Formula (I), at least one of R₁, R₂, R₃, R₄, or R₅ are not hydrogen. In more specific embodiments of Formula (I), at least two of R₁, R₂, R₃, R₄, or R₅ are not hydrogen. In other words, the benzene ring contains the sulfonamide substituent and an additional one or two other substituents.

In other embodiments of Formula (I), the halo active aromatic sulfonamide compound has the structure of Formula (II):

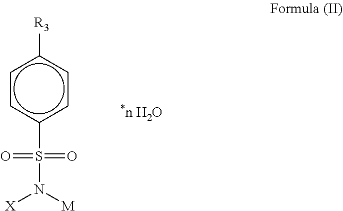

wherein R3 is COOR′; R′ is hydrogen, an alkali metal, an alkaline earth metal, substituted C₁-C₁₈ alkyl, unsubstituted C₁-C₁₈ alkyl, substituted aromatic, or unsubstituted aromatic; X is halogen; M is an alkali or alkaline earth metal; and n is the number of water molecules per molecule of the sulfonamide compound. The N-chloro-4-carboxybenzenesulfonamide compound of Formula (II) is also referred to herein as BENZ. BENZ exhibits a lower chlorine smell than chloramine-T or chloramine-B. When BENZ is combined with at least one fragrance, there is no detectable chlorine smell for most humans.

Two particular sulfonamide compounds contemplated for use are N-chloro-p-toluenesulfonamide (i.e. chloramine-T) and N-chloro-4-carboxybenzenesulfonamide (i.e. BENZ). These two compounds are shown below as Formulas (III) and (IV):

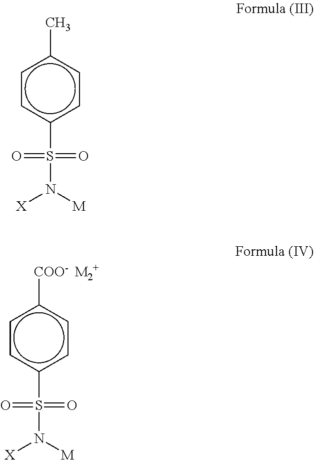

wherein M₂ is hydrogen, an alkali metal, or an alkali earth metal; X is halogen, and M is independently an alkali or alkaline earth metal. Desirably, M₂ is hydrogen, sodium, or potassium. Again, these two compounds can also be hydrated, but do not have to be.

In other particular embodiments, one or more of R₁, R₂, R₃, R₄, and R₅ are substituted with —COOR' (and the others are hydrogen). In this regard, it is believed that when the halo active aromatic sulfonamide compound has two or more ionic charges, that the compound has higher antimicrobial and odor control performance. The antimicrobial performance of these compounds of Formula (I) was not expected, because sulfonamide groups having a halogen atom bonded to the nitrogen atom are not present in molecules having known antimicrobial or odor control properties.

The halo active aromatic sulfonamide compounds of Formula (I) are stable, very soluble in water, do not decompose in aqueous solution, low in toxicity, and have minimal bleach odor.

The halo active aromatic sulfonamide compound (A) may be present in the masonry-based material composition in the amount of about 0.0001 wt % to about 40 wt %, based on the weight of the masonry-based material composition. It is contemplated that the halo active aromatic sulfonamide compound (A) may be present in the masonry-based material composition in different forms, such as in a solution, as a dry powder, as a dry crystal, as dry pellets, as a dry coating, and/or as a hydrated coating. In certain embodiments, the masonry-based material composition can be sold as a dry powder and subsequently combined with water to form a wet mixture. The halo active aromatic sulfonamide compound (A) is present in larger amounts when the composition is in the dry powder form, and the amount is subsequently reduced when water is added to the dry powder.

In further embodiments, the halo active aromatic sulfonamide compound may be present in the masonry-based material composition in the amount of about 0.0001 wt % to about 0.001 wt %, or about 0.001 wt % to about 0.002 wt %, or about 0.002 wt % to about 0.003 wt %, or about 0.003 wt % to about 0.004 wt %, or about 0.004 wt % to about 0.005 wt %, or about 0.005 wt % to about 0.006 wt %, or about 0.006 wt % to about 0.007 wt %, or about 0.007 wt % to about 0.008 wt %, or about 0.008 wt % to about 0.009 wt %, or about 0.009 wt % to about 0.01 wt %, or about 0.01 wt % to about 0.02 wt %, or about 0.02 wt % to about 0.03 wt %, or about 0.03 wt % to about 0.04 wt %, or about 0.04 wt % to about 0.05 wt %, or about 0.05 wt % to about 0.06 wt %, or about 0.06 wt % to about 0.07 wt %, or about 0.07 wt % to about 0.08 wt %, or about 0.08 wt % to about 0.09 wt %, or about 0.09 wt % to about 0.1 wt %, or about 0.1 wt % to about 0.2 wt %, or about 0.2 wt % to about 0.3 wt %, or about 0.3 wt % to about 0.4 wt %, or about 0.4 wt % to about 0.5 wt %, or about 0.5 wt % to about 0.6 wt %, or about 0.6 wt % to about 0.7 wt %, or about 0.7 wt % to about 0.8 wt %, or about 0.8 wt % to about 0.9 wt %, or about 0.9 wt % to about 1 wt %, or about 1 wt % to about 5 wt %, or about 5 wt % to about 10 wt %, or about 10 wt % to about 35 wt %, or about 10 wt % to about 20 wt %, or about 20 wt % to about 30 wt %, or about 30 wt % to about 40 wt %, or any combination of endpoints thereof, based on the weight of the masonry-based material composition.

In some embodiments, the halo active aromatic sulfonamide compound may be present in the final structure (i.e., after application and curing of the masonry-based material composition) in the amount of about 0.0001 wt % to about 40 wt %, based on the weight of the structure formed, including from about 0.0001 wt % to about 0.001 wt %, from about 0.001 wt % to about 0.01 wt %, from about 0.01 wt % to about 0.1 wt %, from about 0.1 wt % to about 1 wt %, from about 1 wt % to about 5 wt %, from about 5 wt % to about 10 wt %, from about 10 wt % to about 20 wt %, from about 20 wt % to about 30 wt %, or from about 30 wt % to about 40 wt %, or any combination of endpoints thereof, based on the weight of the structure formed.

As mentioned above, the masonry-based material compositions of the present disclosure typically include a base material (B). The base material (B) can comprise, for example and without limitation, mortar, cement, grout, drywall, oriented strand board, plywood, lumber, brick, cinder block, metals, sand, gravel, insulation, carpet, stucco and stucco variations, roofing material (e.g., shingles, etc.), plastics, engineered wood/lumber, laminated veneer lumber, glulam, parallel strand lumber, hemp and hemperete, and straw. In some embodiments, the base material (B) can further comprise various additional additives, such as acrylics, latexes, polyvinyl acetates, ethylvinyl acetates, celluloses, surfactants, alcohols, pH stabilizers, thickeners, sealers, cleaners, alkanolamines, water-retentive additives, pigments, polymer additives, paper and/or fiberglass fibers, plasticizers, foaming agents, starch, ground mica, chelating agents, anti-mildew agents, wax emulsions or silanes, potassium sulfate, and/or combinations thereof. In particular embodiments, the base material (B) can comprise a mixture of gypsum and water. In such embodiments, the masonry-based material composition may be used to form, for example, drywall. In other embodiments, the base material (B) may include cement and aggregates, with or without the presence of water. In specific embodiments, the base material can comprise, for example and without limitation, drywall, concrete, mortar, or grout.

In some embodiments, the base material (B) may comprise from about 5 wt % to about 50 wt % cement, including from about 5 wt % to about 10 wt %, or from about 10 wt % to about 20 wt %, or from about 20 wt % to about 30 wt %, or from about 30 wt % to about 40 wt %, or from about 40 wt % to about 50 wt %, or any combination of endpoints thereof, based on the total weight of the base material (B).

In further embodiments, the base material (B) may comprise from about 5 wt % to about 90 wt % aggregates, including from about 5 wt % to about 10 wt %, or from about 10 wt % to about 20 wt %, or from about 20 wt % to about 30 wt %, or from about 30 wt % to about 40 wt %, or from about 40 wt % to about 50 wt %, or from about 50 wt % to about 60 wt %, or from about 60 wt % to about 70 wt %, or from about 70 wt % to about 80 wt %, or from about 80 wt % to about 85 wt %, or from about 85 wt % to about 90 wt %, or any combination of endpoints thereof, based on the total weight of the base material (B).

In some embodiments, the base material (B) comprises from about 20 wt % to about 90 wt % gypsum, including from about 20 wt % to about 30 wt %, or from about 30 wt % to about 40 wt %, or from about 40 wt % to about 50 wt %, or from about 50 wt % to about 60 wt %, or from about 60 wt % to about 70 wt %, or from about 70 wt % to about 80 wt %, or from about 80 wt % to about 90 wt % gypsum, based on the total weight of the base material (B).

In still further embodiments, the base material (B) may comprise from about 0 wt % to about 20 wt % additional additives, including from about 0 wt % to about 0.01 wt %, or from about 0.01 wt % to about 0.1 wt %, or from about 0.1 wt % to about 1 wt %, or from about 1 wt % to about 2 wt %, or from about 2 wt % to about 3 wt %, or from about 3 wt % to about 4 wt %, or from about 4 wt % to about 5 wt %, or from about 5 wt % to about 10 wt %, or from about 10 wt % to about 15 wt %, or from about 15 wt % to about 20 wt %, or any combination of endpoints thereof, based on the total weight of the base material (B).

In particular embodiments, the remainder or balance of the base material (B) consists essentially of water. Again, the composition can be dry (i.e. without water) or wet.

In specific embodiments, the base material (B) comprises from about 5 wt % to about 50 wt % cement, about 5 wt % to about 90 wt % aggregates, and from about 0.01 wt % to about 20 wt % additional additives, with the remaining portion essentially consisting of water.

In other specific embodiments, the base material (B) comprises from about 20 wt % to about 90 wt % gypsum, from about 0.01 wt % to about 20 wt % additives, with the remaining portion essentially consisting of water.

In accordance with the present invention, the aggregates of the base material (B) may include fine and coarse aggregates, which generally occupy a majority (at least 50%) of the volume of the masonry-based material composition. Fine aggregates may include, for example and without limitation, natural sand or crushed stone, and generally have an average particle size of 5 millimeters (mm) or less. Coarse aggregates may include, for example and without limitation, gravels or crushed stone with an average particle size larger than 5 mm, and generally between about 9.5 mm and 37.5 mm.

The average particle size is defined as the particle diameter at which a cumulative percentage of 50% (by volume) of the total number of particles are attained. In other words, 50% of the particles have a diameter above the average particle size, and 50% of the particles have a diameter below the average particle size. The size distribution of the particles will be Gaussian, with upper and lower quartiles at 25% and 75% of the stated average particle size, and all particles being less than 150% of the stated average particle size.

In specific embodiments, the fine and/or coarse aggregates may include sand, gravel, crushed stone, expanded shale, clay, slate, slag, pumice, scoria, perlite, vermiculite, diatomite, barite, limonite, magnetite, ilmenite, hematite, iron, steel punchings or shot, minerals such as silicas, silicates, carbonates (e.g., calcite), sulfates, iron sulfides, and iron oxides, igneous rocks such as granite syenite, diorite, gabbro, peridotite, pegmatite, volcanic glasses, felsite, and basalt, sedimentary rocks such as sandstone, claystone, siltstone, carbonates (e.g., limestone, dolomite, marl, chalk), and chert, and metamorphic rocks, such as marble, slate, phyllite, schist, amphibolite, hornfels, gneiss, and serpentinite, or combinations thereof.

In some embodiments, the fine aggregates may be present in the aggregates of base material (B) in an amount from about 15 wt % to about 20 wt %, or about 20 wt % to about 25 wt %, or about 25 wt % to about 30 wt %, or about 30 wt % to about 35 wt %, or about 35 wt % to about 40 wt %, or about 40 wt % to about 45 wt %, or about 45 wt % to about 50 wt %, or any combination of endpoints thereof, based on the total weight of the aggregates. In further embodiments, the coarse aggregates may be present in the aggregates in an amount from about 50 wt % to about 55 wt %, or about 55 wt % to about 60 wt %, or about 60 wt % to about 65 wt %, or about 65 wt % to about 70 wt %, or about 70 wt % to about 75 wt %, or about 75 wt % to about 80 wt %, or about 80 wt % to about 85 wt %, or any combination of endpoints thereof, based on the total weight of the aggregates.

In some embodiments, the base material (B) may be present in the masonry-based material composition in the amount of about 1 wt % to about 99.99 wt %, based on the total weight of the masonry-based material composition. In further embodiments, the base material may be present in the amount of about 50 wt % to about 99.99 wt %, or about 50 to about 99 wt %, or any combination of endpoints thereof, based on the total weight of the masonry-based material composition. In still further embodiments, the base material (B) may be present in the amount of about 10 wt % to about 20 wt %, or about 20 wt % to about 30 wt %, or about 30 wt % to about 40 wt %, or about 40 wt % to about 50 wt %, or about 50 wt % to about 60 wt %, or about 60 wt % to about 70 wt %, or about 70 wt % to about 80 wt %, or about 80 wt % to about 85 wt %, or about 85 wt % to about 90 wt %, or about 90 wt % to about 91 wt %, or about 91 wt % to about 92 wt %, or about 92 wt % to about 93 wt %, or about 93 wt % to about 94 wt %, or about 94 wt % to about 95 wt %, or about 95 wt % to about 96 wt %, or about 96 wt % to about 97 wt %, or about 97 wt % to about 98 wt %, or about 98 wt % to about 99 wt %, or about 99 wt % to about 99.99 wt %, or any combination of endpoints thereof, based on the total weight of the masonry-based material composition. In specific embodiments, the base material may be present in the amount of at least 50 wt %, or at least 60 wt %, or at least 70 wt %, or at least 80 wt %, or at least 90 wt %, based on the total weight of the masonry-based material composition.

Also disclosed herein are structures and surfaces formed from the masonry-based material compositions as described above. In particular embodiments, these structures and surfaces may include, for example and without limitation, walls, ceilings, floors, tiles, or portions thereof. In some embodiments, the masonry-based material compositions can be used to form drywall. The structures and surfaces may also include, for example and without limitation, grouting, mortar, or sealant.

These structures and surfaces may be formed in a variety of manners. For example, the halo active aromatic sulfonamide compound (A) may be applied and/or otherwise incorporated into the base material (B) using a variety of processes, including crystals, powders, pellets, spray, soaking, and coating. The sulfonamide compound (A) may be added to the base material (B) on-site where it is mixed and then immediately used. Alternatively, the sulfonamide compound (A) may be added to the base material (B) at the factory, and will remain stable for an extended time period and still be ready to use when sold.

It is contemplated the masonry-based materials containing the halo active aromatic sulfonamide compound can be exposed to water/moisture that hydrates the sulfonamide compound and permits its active antimicrobial and odor control ability. Water may also be present via the hydrated sulfonamide compound itself.

While not being limited by theory, it is believed that minor amounts of water, either through the hydrated nature active sulfonamide compound and/or the ambient humidity, will keep the sulfonamide active over an extended period of time compared to other products such as bleach. Thus, the antimicrobial kill performance and/or odor-eliminating performance of the sulfonamide will extend over that time period as well, so that repeated exposure of microorganisms or odor-causing molecules will also be eliminated, even after drying. Extended kill and prophylactic protection of surfaces and structures is thus possible for times of up to 2 weeks, one month, multiple months, or one year, or even multiple years as previously described herein, as long as the sulfonamide compound is not exhausted or decomposed or degraded. Such performance is not obtained by other disinfectants such as bleach, even when they are rewetted. Put another way, known products (bleach, peroxide) generally only kill microorganisms while they are wet, and their killing ability essentially ends after they have dried. Such products provide little, if any, residual protection: if new microorganisms are applied to the surface after the product has dried, those new microorganisms will survive and reproduce. This lack of residual protection by known products is substantially different from the compositions presently disclosed herein.

In addition, the active sulfonamide compound does not cause changes in the physical surface of the masonry-based material, and is not detectable by touch or by other senses—analytical techniques are usually needed. The sulfonamide compound also does not make surfaces “sticky” in the same manner as quaternary compounds.

As described herein, the surfaces and structures formed by the present masonry-based materials can be effective to achieve extended kill and prophylactic protection, including with respect to a variety of microorganisms, including, for example, Staphylococcus aureus (i.e. S. aureus), Pseudomonas aeruginosa (i.e. P. aeruginosa), and Clostridium difficile (i.e. C. difficile). The structures and surfaces formed from the masonry-based material compositions of the present disclosure may achieve high microbial killing and/or odor-reducing performance over extended periods of time. In particular embodiments, the structures and surfaces can maintain a killing performance of at least 85% after 24 hours, or at least 90% after 24 hours, or at least 95% after 24 hours, or at least 98% after 24 hours, or at least 85% after 48 hours, or at least 90% after 48 hours, or at least 95% after 48 hours, or at least 98% after 48 hours, or at least 85% after 72 hours, or at least 90% after 72 hours, or at least 95% after 72 hours, or at least 98% after 72 hours, or at least 85% after 168 hours, or at least 90% after 168 hours, or at least 95% after 168 hours, or at least 98% after 168 hours, or at least 85% after 336 hours, or at least 90% after 336 hours, or at least 95% after 336 hours, or at least 98% after 336 hours.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. An antimicrobial and odor-reducing masonry-based material composition, comprising:
a base material; and
a halo active aromatic sulfonamide compound of Formula (I): 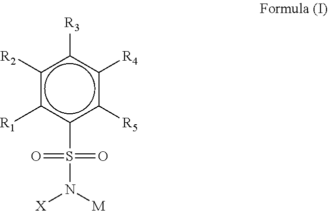
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic;
R′ is hydrogen, an alkali metal, an alkaline earth metal, substituted C₁-C₁₈ alkyl, or unsubstituted C₁-C₁₈ alkyl; and
R″ is hydrogen or substituted or unsubstituted C₁-C₁₈ alkyl, where the two R″ groups in CON(R″)₂ and N(R″)₂ may be independently selected from each other;
X is halogen; and
M is an alkali or alkaline earth metal.

2. The masonry-based material composition of claim 1, wherein at least one of R₁, R₂, R₃, R₄, or R₅ is not hydrogen.

3. The masonry-based material composition of claim 1, wherein the halo active aromatic sulfonamide compound is chloramine-T or N-chloro-4-carboxybenzenesulfonamide.

4. The masonry-based material composition of claim 1, wherein the composition comprises from about 0.01 wt % to about 20 wt % of the halo active aromatic sulfonamide compound.

5. The masonry-based material composition of claim 1, wherein the composition comprises from about 80 to about 99.99 wt % of the base material.

6. The masonry-based material composition of claim 1, wherein the base material comprises a mixture of cement, aggregates, and water.

7. The masonry-based material composition of claim 6, wherein the base material comprises from about 5 wt % to about 50 wt % cement, from about 5 to about 90 wt % aggregates, and the balance consisting essentially of water.

8. The masonry-based material composition of claim 6, wherein the base material further comprises from about 0.01 to about 20 wt % additional additives.

9. The masonry-based material composition of claim 8, wherein the additional additives include at least one of a pigment, a latex polymer additive, and a water-retentive additive.

10. The masonry-based material composition of claim 6, wherein the aggregates includes sand, gravel, crushed stone, expanded shale, clay, slate, slag, pumice, scoria, perlite, vermiculite, diatomite, barite, limonite, magnetite, ilmenite, hematite, iron, steel punchings or shot, silicas, silicates, carbonates, calcite, sulfates, iron sulfides, iron oxides, granite syenite, diorite, gabbro, peridotite, pegmatite, volcanic glasses, felsite, and basalt, sandstone, claystone, siltstone, limestone, dolomite, marl, chalk, chert, marble, slate, phyllite, schist, amphibolite, hornfels, gneiss, and serpentinite, or a combination thereof.

11. The masonry-based material composition of claim 6, wherein the aggregates comprise a combination of fine aggregates and coarse aggregates.

12. The masonry-based material composition of claim 11, wherein the fine aggregates are present in the aggregates in an amount of about 15 wt % to about 50 wt %, based on the total weight of the aggregates.

13. The masonry-based material composition of claim 11, wherein the coarse aggregates are present in the aggregates in an amount of about 50 wt % to about 85 wt %, based on the total weight of the aggregates.

14. The masonry-based material composition of claim 11, wherein the fine aggregates have an average particle size of 5 mm or less.

15. The masonry-based material composition of claim 11, wherein the coarse aggregates have an average particle size of at least 5 mm.

16. The masonry-based material composition of claim 1, wherein the base material comprises a mixture of gypsum and water.

17. The masonry-based material composition of claim 16, wherein the gypsum is present in the base material in an amount of about 70 wt % to about 90 wt %, based on the total weight of the base material, and the balance of the base material consists essentially of water.

18. A structure formed from the masonry-based material composition of claim 1.

19. The structure of claim 18, wherein the structure is at least a portion of a wall, floor, ceiling, tile, drywall, grouting, mortar, or sealant.

20. The structure of claim 18, wherein the structure maintains at least a 98% antimicrobial killing performance after 168 hours.
